(19) United States
(12) Patent Application Publication
(10) Pub. No.: US 2005/0234806 A1
(43) Pub. Date: Oct. 20, 2005

(54) System and method for a continuous auction market with dynamically triggered temporal follow-on auctions

(75) Inventors: Donald R. Findlay, Toronto (CA); Judith N. Robertson, Toronto (CA); Karl Abbott, Markham (CA); Douglas W. Gerhart, Toronto (CA); Roula Haddad, Toronto (CA); Eric E. Barnhorst, Toronto (CA); Douglas E. Steiner, Toronto (CA)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Markets Inc.

(21) Appl. No.: 11/076,902

(22) Filed: Mar. 11, 2005

Related U.S. Application Data
(60) Provisional application No. 60/562,980, filed on Apr. 19, 2004.

(51) Int. Cl. G06F 17/60

(52) U.S. Cl. 705/37

(57) ABSTRACT

Systems, methods, and programs consistent with the present invention use the trading price for a fungible asset established in a continuous auction market as the set price for a call auction for the asset that occurs some time after the continuous market trade that establishes the trading price. Interested participants may submit orders at the established price that will be matched with complementary orders, if any have been submitted, when the call auction occurs, and a trade will be executed.

### RELATED APPLICATIONS

This application is related to and claims benefit and priority of U.S. Provisional Application No. 60/562,980 entitled “System and Method for a Continuous Auction Market with Dynamically Triggered Temporal Auctions (Follow-on Auctions)” filed Apr. 19, 2004, which is incorporated herein by reference.

### DESCRIPTION OF THE INVENTION

1. Field of the Invention

This invention generally relates to automated systems for efficient asset markets, and more particularly, to systems and methods for call auction trades of fungible assets following continuous auction trades.

2. Background of the Invention

Fungible assets are a class of assets where each instance of a particular asset is interchangeable with another instance of the same asset. Examples of fungible assets include currencies, public securities, frequent flyer mile points, industrial commodities, and agricultural commodities. Real estate, on the other hand, is not a fungible asset.

Over time specialized markets have evolved for buyers and sellers to trade particular types of fungible assets in various ways. Examples of these markets include stock exchanges, options exchanges, and commodities exchanges. Using these markets a plurality of buyers and a plurality of sellers may negotiate and execute a plurality of trades. Each trade is a transaction wherein a particular buyer agrees to buy, and a particular seller agrees to sell, a particular quantity of a particular fungible asset at a particular price at the time the trade occurs.

Current markets in which fungible assets are traded typically employ a public auction process to discover the price at which a particular quantity of a particular fungible asset may be bought or sold at a particular point in time. Current markets employ a variety of different auction methods, including the single-sided English auction, the two-sided English auction, and the Dutch auction.

The most common conventional auction process employed in markets for fungible assets is the continuous two-sided English auction. In this auction process, the market continuously attempts to match the seller or sellers willing to sell a particular asset at the lowest price with the buyer or buyers willing to buy the asset at the highest price. Examples of markets that employ the continuous two-side English auction process are The New York Stock Exchange, The London Stock Exchange, The Tokyo Stock Exchange, The Chicago Board of Trade, and the Toronto Stock Exchange.

To participate in a continuous two-sided English auction market, a buyer participant places an order to buy a particular quantity of a particular asset at a particular price, and a seller participant places an order to sell a particular quantity of a particular asset at a particular price. The orders placed by buyers are called “bids,” and the orders placed by sellers are called “offers”. For a particular asset trading in a particular market, the best bid is the bid at the highest price, and the best offer is the offer at the lowest price. The market attempts to match best bids and best offers to accomplish a trade. Participants negotiate in the market by adjusting their bids and offers. Whenever a buyer is willing to buy at the best offer price, or a seller is willing to sell at the best bid price, a trade occurs between the parties.

In continuous markets, there is normally a gap or spread between the best bid price and the best offer price, with the bid price being lower than the offer price. As soon as the spread becomes zero or when the best bid price exceeds the best offer price, the orders constituting the best bid and the best offer are matched and executed, subject to any volume constraints, and a trade occurs. After the trade, the market returns to its normal condition with a spread between the current best bid and offer prices.

To attract more orders, continuous markets typically advertise the currently prevailing best bid and offer in what is called a market quotation. Each market quotation describes for a particular fungible asset trading in a particular market the currently prevailing best bid price, best offer price, the quantity of the asset in demand at the best bid, and the quantity of the asset available at the best offer. High speed telecommunications networks typically distribute market quotations so that they are available to participants in real-time.

The continuous auction trading model is very successful. It does, however, present a number of problems for certain buyers and sellers.

For one, broadcasting market quotations informs the marketplace participants about the trading intentions of the most aggressive buyers and sellers in the market. In some cases, these aggressive buyers and sellers may wish to trade without publicly disclosing their trading intentions. For example, participants who seek to buy or sell large quantities (big blocks) of a particular fungible asset often do not want their intentions to become public, because the order information affects prices. The market tends to react to the perception of supply or demand created by the large order size, making prices higher or lower than they otherwise would have been. There are also many other types of participants who, and reasons to, wish to keep their orders secret.

Moreover, even if a participant tries to keep their orders from appearing as quotations by bidding or asking at the current market price, public quotation can still occur. Specifically, participants place orders to participate in an auction and, ultimately, a trade, and the markets matches all orders continuously. Because there are inherent delays in placing a new order in a market, a particular order may not be executed when it is entered if another new order gets to the market first. Instead, it may end up constituting the best bid or offer and consequently be disseminated widely as a market quotation. In addition, many markets, such as the NASDAQ, use an open book order system, where all orders are available for public inspection regardless of whether they happen to appear as market quotations.

Another problem is the limited amount of information supplied by conventional market quotations and open book order systems. An order or quotation reveals only the prices and quantities of the best orders in the order book at that time. A market quotation does not represent the complete and accurate intentions of the participants interested in the particular fungible asset and market. For example, a participant who wishes to sell a large block, typically does so as several small orders. So information on the small orders does not reveal the complete and accurate intentions of the participants. For a participant that wishes to trade quantities of a particular fungible asset that are substantially larger than the quoted quantities in the market, such as institutional investment managers, the continuous auction model typically does not supply information about the prices at which these larger quantities can be traded.

It is desirable to solve the problems continuous auction models present to large quantity buyers and sellers.

Conventional continuous auction markets have another problem that stems from the delay between when an order is placed and when the order is executed. Conventional market participants may place what is referred to as a market order. A market order is an order for which no particular price is specified. Market orders are matched against the currently prevailing best bid or best offer at the time the order is received and processed. Since the market matches orders continuously, the best bid or offer may change after a particular market order has been submitted and before it is executed. The result is that a participant does not know with certainty at what price the order will execute, although the participant placed the order based on the most current market quotation. Similarly, if the quantity of the market order exceeds the quantity available at the current best bid or offer, then the participant will not be able to anticipate the prices at which the entire order will be filled, because typically he only sees the best quotation, and there is no information available to him about the price and size of the next best bids or offers at the time the market order is placed.

Another problem affects buyers or sellers who wish to trade as market price takers rather than as market price setters. These participants wish to trade when the market achieves a particular price level. The continuous auction process provides no way for these participants to react to a particular quotation price, because the price may have changed before a new order can be entered and matched at the desired price indicated by the quotation.

There are current systems that address some aspects of these problems. For example, current temporal call markets, such as the POSIT™ market offered by ITG Inc., provide an alternative to continuous auction markets for participants who wish to trade without disclosing their trading intentions. In temporal call markets, buy orders and sell orders for a particular fungible asset are matched at a price taken from another market at a particular instant in time. In some cases the particular time is chosen at random and is unknown to all participants. In other cases, the time is predetermined to be the same time each day, which is known to participants in advance. In other cases, a special price, such as the closing price of the asset in another market, is used.

Call markets, however, present their own problems. For instance, the selection of a price determined by another market does not typically reflect the price at which participating buyers and sellers would have chosen, or are willing, to trade, regardless of when the pricing occurs. Another problem is that the selection of a price other than the price of the orders of the involved buyers and sellers leaves the temporal call auction price open to manipulation by participants or non-participants. For example, unscrupulous individuals may drive the price of a thinly traded issue on the New York Stock Exchange (NYSE) up or down just before noon, knowing that POSIT trades will be based on the issue's noon NYSE price.

Another problem is that temporal auctions that run at either pre-defined times or at random times do not typically coincide with the time at which participating buyers or any sellers wish to trade. Unless both buyers and sellers are interested and able to place orders at the time that the temporal auction runs, matches are unlikely.

At least one system has been proposed using temporal call auction techniques to address unfairness in the market due to communication network delays that would otherwise disadvantage certain market participants. U.S. patent application 2002/0178108 describes the use of auctions at pre-determined or random times. This system, therefore, is addressed to solving problems other than those identified above.

Accordingly, it is desirable to develop a system that addresses all the problems of call markets for fungible assets.

### SUMMARY OF THE INVENTION

Trading systems, computer programs, and methods consistent with the present invention dynamically launch and run a temporal call auction at points in time when buyers and sellers have demonstrated an interest in trading, at a price determined by interested buyers and sellers.

More specifically, one embodiment of the invention comprises i) an order-driven, continuous auction market in which participating orders are matched as they are entered, and ii) a follow-on call auction market in which participating orders are subsequently matched at a trade price for a particular fungible asset established as a function of the continuous market trade price.

Other embodiments according to the invention provide methods, systems and computer program products for trading fungible assets. The methods, systems and computer program products may perform operations comprising obtaining a price for an asset from a continuous auction trade, accepting a plurality of follow-on auction orders for the asset, conducting a follow-on auction for the asset at a price determined as a function of the price obtained for the asset from the continuous auction trade, wherein the plurality of follow-on auction orders are matched, and executing the matched follow-on auction orders.

Other embodiments according to the invention provide methods, systems and computer program products for trading fungible assets that may perform operations comprising obtaining a price for an asset from a continuous auction trade, accepting a plurality of follow-on auction orders for the asset, conducting, after a delay period, a follow-on auction for the asset based on the price obtained for the asset from the continuous auction trade, during which the plurality of follow-on auction orders are processed for matches, if any, and facilitating execution of any matched orders.

Yet another embodiment consistent with the invention provides a fungible asset market order comprising an order type from a group comprising: bid and offer, an order price, and an auction eligibility marker from a group comprising: continuous auction, follow-on auction, and both continuous and follow-on auction.

Still other embodiments consistent with the invention provide methods and systems for trading fungible assets that include operations comprising: obtaining a parameter regarding a continuous auction trade, determining whether the parameter meets a threshold, and conducting a follow-on auction for the asset, at a price established by the continuous auction trade, if the parameter meets the threshold.

Many objects and advantages of the invention will be set forth in part in the description which follows, and in part will be obvious from the description, or may be learned by practice of the invention.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the invention and together with the description, serve to further explain the invention.

FIG. 1 is a state diagram illustrating exemplary modes for a fungible asset in a market consistent with the invention;

FIG. 2 is a flow chart illustrating a process for the follow-on auction mode 135 consistent with the present invention;

FIG. 3 is a state diagram illustrating an exemplary delay mode for a fungible asset in a market consistent with the invention;

FIG. 4 is a timeline illustrating an exemplary sequence of events in a fungible asset market consistent with the invention; and

FIG. 5 illustrates an exemplary computing system that can be used to implement embodiments of the invention.

### DETAILED DESCRIPTION

Overview

Consistent with the present invention, systems, computer programs, and methods are provided for anonymously negotiating and matching buy and sell orders in a fungible asset trading market. Furthermore, systems, computer programs, and methods consistent with the present invention use the trading price for a fungible asset established in a continuous auction market as the set price for a call auction for the asset that occurs some time after the continuous market trade that establishes the set price. Interested participants may submit orders at the established set price that will be matched with compatible orders, if any have been submitted, when the call auction occurs, and a trade will be executed.

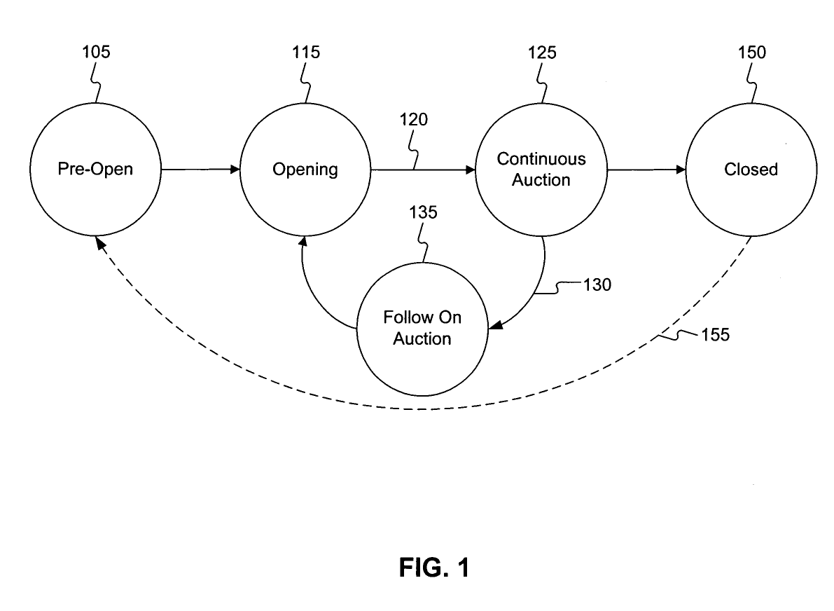

FIG. 1 is a state diagram illustrating exemplary modes for a fungible asset in a market consistent with the invention. Such a market may be implemented in a system using conventional data processing equipment and communications networks and custom software. In the embodiment shown, the market system starts each session in a pre-open mode 105. For example, the market system may start the pre-open mode 105 at 6:00 AM each weekday. In the pre-open mode 105, participants may place new orders for an asset, or change or cancel existing orders, but no matching occurs.

Next, the market system transitions to an opening mode 115 to clear any pending open executable orders for each asset in the market. For example, the market system may enter opening mode 115 at 9:30 a.m. each weekday. In opening mode 115, existing orders for each security are matched, for example on the basis of price and time of entry priority, and trades are executed for matching orders. In one embodiment, if the terms of an order (e.g., minimum fill size, etc.) cannot be met, then the system excludes the order from the opening match and other open orders are re-evaluated without considering the excluded order. In one embodiment, the system calculates an execution price of the opening trades, which is known as the Calculated Opening Price (COP). For example, the COP may be calculated as the mid-point of the range of prices that results in the maximum execution quantity.

When no more trades can be executed for a particular asset in opening mode 115, the system enters continuous auction mode 125 (CAM) for that asset. In continuous auction mode 125, the system compares new and changed orders for an asset with existing orders for the asset based on factors such as price, order time priority, special terms, and fill size constraints. If one or more matches are recognized, the system executes a trade in the CAM 125.

An executed trade for a particular asset in the CAM 125 triggers the system to enter the follow-on auction mode 135 (FOAM) for that asset. In the FOAM 135, the system optionally collects orders for a period of time and then holds a temporal call auction at a price related to the triggering continuous auction price. In one embodiment, the mode of each asset in the market is independent, such that when a particular asset enters a mode such as FOAM 135, this does not affect the modes of other assets in the market.

At the call auction time, the system matches the call auction orders and executes trades. After the FOAM 135 completes, the system transitions to the opening mode 115 to match and execute any accumulated continuous auction orders for the asset, then transitions again to the CAM 125. Thus, during a trading session an asset periodically moves from CAM 125 to FOAM 135 to Opening Mode 115 and back to CAM 125. This cycle can occur zero or more times per day.

At the end of a trading session when the market closes, the system transitions to the closed state 150. For example, the 'system may transition to the closed state at 4:00 pm weekdays.

At the pre-opening time of the next trading session, for example 6:00 am on weekdays, the system transitions 155 from closed mode 150 to pre-open mode 105.

Various embodiments of the invention provide variations to the described states and transitions. For example, a trade execution in the opening mode 115 may trigger a transition (not shown) to follow-on auction mode 135 for the traded asset.

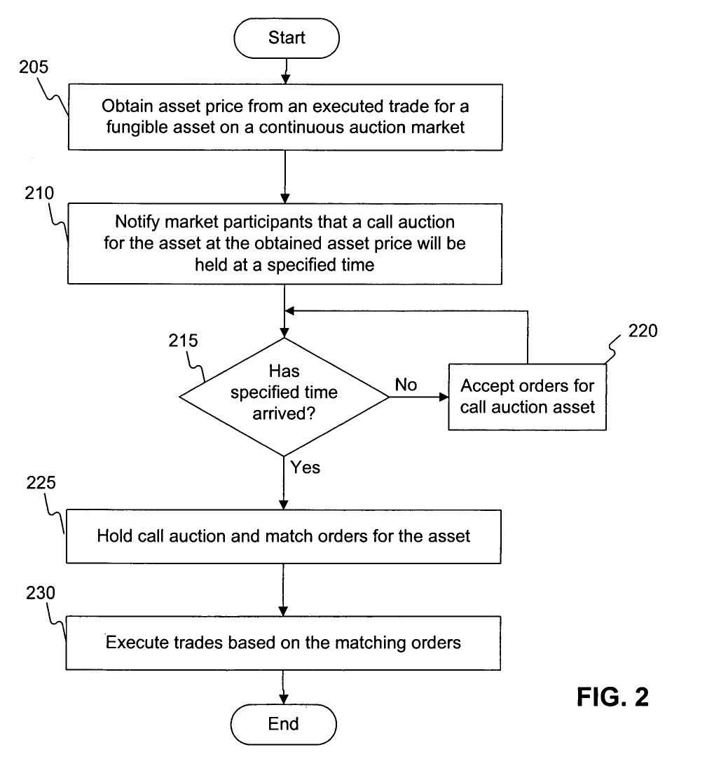

FIG. 2 is a flow chart illustrating an exemplary process for the follow-on auction mode 135 consistent with the present invention. The illustrated process may be executed by software and/or hardware in a data processing system. As shown, the process begins by obtaining a price for an asset from an executed trade for the asset in a continuous auction (step 205).

Next, the system executing the process notifies market participants, for example via instant messaging or a pop-up window on a user interface, that a call auction for the asset will be held at a specified time at a price based on the continuous auction trade price (step 210).

The process then enters a loop, checking whether the call auction time has arrived (step 215), and if not (step 215, No), accepting orders for the asset that is the subject of the call auction (step 220).

When the specified call auction time arrives (step 215, Yes), the system performs the call auction, matching buy and sell orders for the asset at the specified price (step 225).

Finally, the system executes trades among the matching call auction orders (step 230).

Orders

In one embodiment, a market according to the invention includes a central order book and means for a plurality of participants to submit a plurality of orders to it.

Each order submitted to the central order book is either a sell order or a buy order. Each sell order is a commitment made by a selling participant to sell up to a specified quantity of a specified fungible asset at a price no less than a specified limit price. Each buy order is a commitment made by a buying participant to buy up to a specified quantity of a specified fungible asset at a price no higher than a specified limit price.

A limit price is a constraint on the price at which a particular buy order or sell order may be executed. In the case of an order to sell, the limit price is the minimum price that the seller will accept for each unit of the fungible asset sold. A higher price, however, is both acceptable and preferable. In the case of an order to buy, the limit price is the maximum price that the buyer is willing to pay for each unit of fungible asset purchased. A lower price, however, is both acceptable and preferable.

The price of an order may be an absolute price (e.g., $7.84) or relative (pegged) price. Acceptable values for a relative price include bid, mid, and ask. In one embodiment, orders with relative prices may also include a limit price, such as buy at the bid, but no higher than $10.25. Orders entered using a relative price when a valid market data quote does not exist may be rejected. Active orders with relative prices may be suspended if the market data quote for that security is determined to be invalid. A minimum price increment for an order, such as $0.01, may be set by the market system provider.

The lot size for an asset order may be set on an asset-by-asset basis and order quantities may be required to be integer multiples of the lot size for each particular asset. In one embodiment, the matching algorithm (discussed below) will only generate fills in integer multiples of the lot size, and thus the minimum fill (greater than zero) is one lot. The minimum order size may also be set on an asset-by-asset basis. In one embodiment, the size of any order submitted must be equal to or greater than the minimum order size specified for the particular asset that is the subject of the order.

In one embodiment, a participant may specify fill constraints with an order. For example, a minimum fill size may optionally be specified for an order as an integer multiple of the lot size for the asset. In this example, the first fill for that order generated by the market system will be equal to or greater than the minimum fill size specified on the order, and subsequent fills will be in any integer multiple of the lot size for that asset. In this embodiment, if the minimum fill size constraint cannot be met in a particular match, the order will remain in the order book until its fill size constraint can be met, or it expires or is cancelled. As another example of fill constraints, participants may mark an order to be “All or None”. Any order marked all or none either will be filled in its entirety or will remain in the order book until its fill size constraint can be met, or it expires or is cancelled.

In one embodiment, the contents of the order book are kept secret to prevent the disclosure of the trading intentions of buyers or sellers. In another embodiment, participants may indicate on their orders whether they wish the order to be published in a quotation or not. In yet another embodiment, all orders participating in the continuous market and constituting the prevailing best bid or best offer are published in a market quotation. Other embodiments include combinations of these embodiments.

In one embodiment consistent with the invention, each order is marked by the participant to indicate whether it should participate in the continuous matching market or not, and is similarly marked to indicate whether it should participate in the follow-on auction market or not. In another embodiment, an order automatically participates in both the continuous auction and the follow-on call auction. In one embodiment, any order added to the central order book remains there until either it is cancelled or matched and executed. In other embodiments, orders may expire after a specified time period, or not be entered in the central order book if not matched immediately.

In one embodiment, orders are assumed to be day orders, and are in force until the end of the trading day on which they were entered, unless they are marked “Immediate or Cancel” or “Good Till Cancelled”. The treatment of an order marked “Immediate or Cancel” will vary depending on any special terms for the order and the state of the system at the time the order is entered. In one embodiment, the market system treats Immediate or Cancel (IOC) orders according to Table 1:

TABLE 1

| | | IOC Order | IOC Order |
|---|---|---|---|
| IOC Order | IOC Order entered | entered | entered |
| marked for: | during Pre-Open | during CAM | during FOAM |
| Continuous & | Hold until Opening, | Execute and | Execute in |
| Follow-On | execute and cancel | cancel balance | auction and |
| Auctions | balance. | | cancel balance |
| Continuous | Hold until Opening, | Execute and | Hold until |
| only | execute and cancel | cancel balance | CAM reopens, |
| | balance. | | execute and |
| | | | cancel balance |
| Follow-On | Hold and execute in | Hold and | Execute in |
| only | first FOAM | execute in | auction and |
| | | first FOAM | cancel balance |

Thus, in this embodiment certain IOC orders may be held for some period of time before they are executed.

Continuous Auction and Matching

In one embodiment consistent with the invention, when a new order is added to the order book, and the order is marked to indicate that it should participate in the continuous market, it is immediately submitted to the continuous auction process. When an order for a particular fungible asset is submitted to the continuous auction process, it is compared with all of the existing, remaining orders (i.e., unfilled orders) in the order book that are participating in the continuous auction to determine if a match is possible.

A particular new continuous auction order matches a remaining order in the order book when the following conditions are met:
1) a buy order can only be matched with a sell order and visa versa,
2) the orders must be for the same fungible asset, and
3) the limit price specified in the buy order must be equal to or greater than the limit price specified in the sell order.

In one embodiment consistent with the invention, when more than one remaining order matches a particular new order, the system chooses the remaining order with the highest priority to match with the new order. To facilitate this, the system ranks the priority of remaining orders based on their limit price and time of placement in the order book. More specifically, the potentially matching remaining orders are first ranked by price. In the case of buy orders, an order with a higher limit price ranks ahead of an order with a lower limit price. In the case of sell orders, an order with a lower limit price ranks ahead of an order with a higher limit price. Next, among orders at the same price, an order with an earlier time of entry into the order book ranks ahead of an order with a later time of entry. In other embodiments, orders are ranked by other criteria, such as whether their quantity satisfies a new order's quantity. In yet other embodiments, orders are not ranked, but instead matches are made on a pro rata basis, or based on a variation of pro rata matching.

When a particular new order is matched with a particular remaining order, a trade is executed. The participant who submitted the sell order sells, and the participant who submitted the buy order buys, a specified quantity of the particular fungible asset specified in the matching orders at a specified price. The specified quantity that is traded is equal to the lesser of the quantity specified in the buy order and the quantity specified in the sell order. The final price at which the trade occurs is based on the orders being executed. In one embodiment, the final price is equal to the average of the limit price specified in the buy order and the limit price specified in the sell order. In other embodiments, the final price is calculated in different ways, such as a weighted average price calculation that takes into account the quantities in each participants' orders, or simply the ask price. The particular fungible asset exchanged when two orders are matched is referred to as the traded asset, the quantity of the fungible asset exchanged is referred to as the trade size, and the price paid by the buyer for each unit of the traded asset purchased is referred to as the trade price.

When a new order is matched with a remaining order in the continuous auction, the quantities of both orders are reduced by the trade size. If, after this reduction, the quantity of a remaining order is zero, it is removed from the order book because it has been fully executed or filled. Similarly, if after this reduction the quantity of the new order is zero, it is removed from the order book. If, after this reduction, the quantity of a remaining order is greater than zero, it remains in the order book with its quantity reduced by the amount exchanged. If, after this reduction, the quantity of the new order is greater than zero, it remains in the order book with its quantity reduced. An order that is marked to indicate that is should participate in the continuous market continues to be matched in this manner until either no more matches are possible, or it is fully executed. If a new order cannot be fully executed, it becomes a remaining order in the order book.

In one embodiment, if the limit price of a buy order is greater than the limit price of the sell order it is being matched with, the trade price is calculated as the mid-point between the worst executable buy order price and the worst executable sell order price.

In another embodiment, if a continuous auction order has a fill size constraint that cannot be met, it is excluded from the potential match, and the potential match is re-evaluated. This exclusion is repeated until a match is executed or determined not to be possible.

Follow-On Auction

Shortly after a trade occurs in the continuous auction process, one embodiment consistent with the present invention performs the following operations:
1) information concerning the trade, including the traded asset, trade size, and trade price, is communicated to the market participants,
2) a follow-on auction in the traded asset at the trade price is scheduled to occur at a specified time in the future, and
3) information concerning the follow-on auction, including the fungible asset to be auctioned, the price it is being auctioned at, and the time of the auction, is communicated to the market participants.

A follow-on auction is a call auction for a single particular fungible asset that is triggered by a continuous auction trade and that occurs at a specified time and at a specified price based upon the triggering continuous auction trade price. In one embodiment, a single follow-on auction is held; in other embodiments, more than one follow-on auction is held.

The execution time of the follow-on auction is determined dynamically based on events in the continuous auction market. In one embodiment, the execution time is calculated as a pre-defined period after a trade for that particular asset is executed in a continuous market. In another embodiment, the period is not pre-defined, but instead may vary randomly, according to some formula, or according to subsequent trades for the same asset in the continuous auction market.

In one embodiment, the price used for the follow-on auction is determined dynamically and is equal to the price of the trade executed in the continuous market that triggered the follow-on auction. In one embodiment, any continuous auction trade may be a trigger event. In another embodiment, only a trade that meet specified criteria, such as a minimum trade quantity, is a trigger event.

In another embodiment, the follow-on auction price is some function of the continuous auction trade price. In yet another embodiment, the auction price is set by a subsequent continuous auction trade. For example, a first continuous auction trade may be used as a trigger event for a delay period that delays initiation of a follow-on auction. Any subsequent continuous auction orders for the particular asset may be executed in the continuous auction during the delay period, and the trade price of the last delay-period trade used for the follow-on auction price.

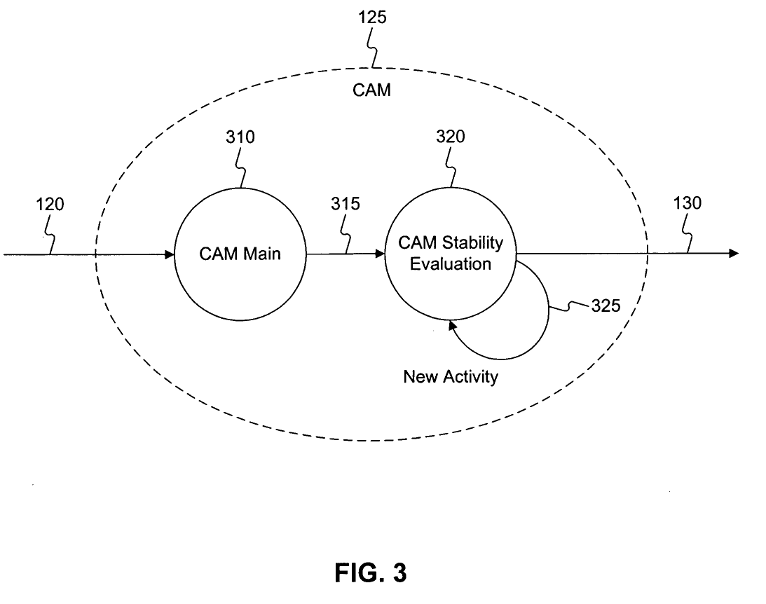

FIG. 3 is a state diagram used to explain an exemplary delay period mode for a fungible asset in a market consistent with the invention. As shown, continuous auction mode 125 contains two phases. During the first phase, CAM Main phase 310, the system compares new and changed continuous auction orders for an asset with existing orders for the asset based on factors such as price, order time priority, special terms, and fill size constraints. If one or more matches occur, the system executes a trade in the CAM Main phase 310. After a trade in CAM Main phase 310 occurs, the CAM 125 enters a CAM stability evaluation phase 320. In this phase, the system waits for a period of time to confirm that the market is ready for a follow-on auction for the asset. If a new continuous auction activity 325 occurs during this time, such as a trade for the asset at either the same or different price, the system remains in the CAM stability evaluation phase 320 for an additional period of time. If no continuous auction activity 325 occurs during the wait period, then the system transitions 130 to the FOAM 135 for the asset. As noted above, at transition 130 the system may broadcast a message announcing the follow-on auction price and time.

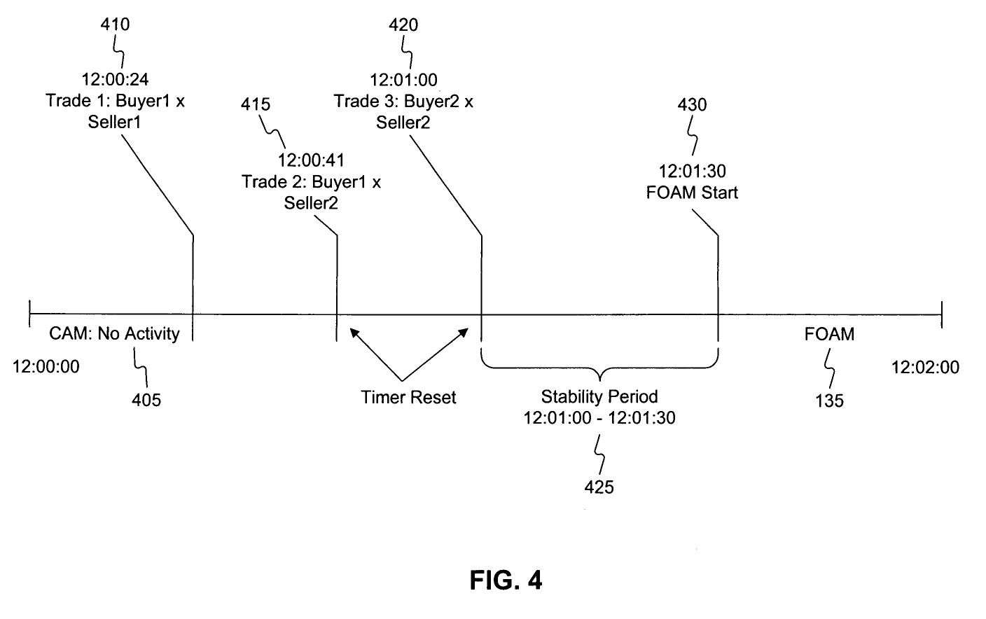

FIG. 4 is a timeline illustrating an exemplary sequence of events in a fungible asset market consistent with the invention. Events such as those illustrated in FIG. 4 may be implemented by a market system that includes a CAM stability evaluation phase 320. In this example, the CAM stability evaluation phase 320 is set to last for a 30 second period of time. As shown, at time 12:00:00, the system is in CAM 125 for a certain asset. During period 405 from 12:00:00 until 12:00:23, no activity, such as a trade, occurs for the asset. At time 12:00:24 (410), a trade, Trade 1, occurs for the asset between Buyer1 and Seller1, and this trade triggers the 30-second CAM stability evaluation phase 320.

At 12:00:41 (415), before the 30 second period expires, Trade 2 occurs between Buyer 1 and Seller 2. Trade 2 restarts the timer that measures the 30-second CAM stability evaluation phase 320.

At time 12:01:00 (420), before the restarted 30 second timer period expires, Buyer 2 and Seller 2 enter into Trade 2, and again the system resets the 30 second CAM stability evaluation phase timer.

Next, a 30 second stability period 425 passes from 12:01:00 (420) until 12:01:30 (430) during which no reset-triggering activities occur. Consequently, the system enters FOAM 135 for the asset at 12:01:30. In embodiments that employ a priority matching scheme during FOAM 135, any correctly priced existing and new orders from Buyer1, Buyer2, Seller1, and Seller2 may be included in a priority group that is given matching preference because these buyers and sellers triggered the FOAM 135.

One of ordinary skill will recognize that the times in this example are arbitrary and may be adjusted without departing from the principles of the invention.

In one embodiment consistent with the invention, at the time each follow-on auction occurs, all the buy orders participating in the auction (e.g., buy orders marked for the follow-on auction) are matched on a pro rata basis with all the sell orders participating in the follow-on auction (e.g., sell orders marked for the follow-on auction) at the determined follow-on auction price. In another embodiment, the buy and/or sell orders are priority ranked based on various criteria, such as order entry time, limit price, and/or quantity, and matched in order of ranking.

To be eligible to participate in a particular follow-on auction, an order must meet the following requirements:
1) it must be marked by the participant who submitted it to indicate that it should participate in follow-on auctions,
2) it must be an order for the fungible asset that is being auctioned in the follow-on auction,
3) if it is a sell order, its limit price must be equal to or lower than the follow-on auction price, and
4) if it is a buy order, its limit price must be equal to or higher than the follow-on auction price.

Follow-On Auction Matching

In one embodiment, all buy orders with a limit price equal to or greater than the follow-on call auction price and all sell orders with a limit price equal to or less than the call auction price are considered for potential matches during the follow-on auction.

In one embodiment, orders in the match that were part of the CAM trade or trades that triggered the FOAM 135 are given priority. This may include any orders that traded prior to the last trade 325 that reset the CAM stability evaluation phase 320.

In one embodiment consistent with the invention, when a follow-on auction occurs, the quantities specified in all the sell orders participating in the auction are summed to compute the total sell quantity, and the quantities specified in all the buy orders participating in the auction are summed to compute the total buy quantity. If either the total sell quantity or the total buy quantity is zero, no orders are matched. If the total sell quantity is equal to the total buy quantity, and both are greater than zero, the aggregate of the sell orders are matched with the aggregate of the buy orders. If the total sell quantity and the total buy quantity are greater than zero but unequal, then the orders are matched on a pro-rata basis. More specifically, if the total sell quantity is less than the total buy quantity, all of the sell orders are fully matched in aggregate with a pro rata portion of all the buy orders, and vice versa if the total buy quantity is less than the total sell quantity.

In one embodiment, if after the pro rata allocation one or more of the orders on the constrained side do not have their minimum fill constraints met, an order may be selected and removed from the matching process and the match recomputed. This will increase the chances of meeting the minimum fill constraints for the remaining orders. In one embodiment, the order(s) selected for removal is the order(s) most difficult to fill, based on size, minimum fill constraints, or other factors.

In another embodiment, instead of a pure pro rata scheme, matching priority may be given to those orders or those participants whose orders triggered the follow-on auction. In still another embodiment, matching priority may be based on other factors such as time of the order or quantity.

When a particular order is matched in a follow-on call auction, the quantity of that order executed is subtracted from the order quantity. If, after this subtraction, the remaining quantity of the order is zero, the order is removed from the order book. If, after this subtraction, the remaining quantity is greater than zero, the order remains in the order book with the reduced quantity. In one embodiment, any order added to the central order book remains there until either it is cancelled or matched and executed. In other embodiments, orders may expire or be removed if they do not immediately match.

In one embodiment consistent with the invention, at the end of the follow-on auction allocation process, a single trade is reported to the public reflecting the aggregate quantity traded and the crossing price. In addition, individual execution reports are returned to the trading participants.

Market Data Processing System

In one embodiment consistent with the invention, each market participant interacts with a central server system using an interactive participant apparatus, such as a computer workstation that communicates with the central server via a data communication network, and the central order book and follow-on auctions are implemented as software application(s) executing on the central server.

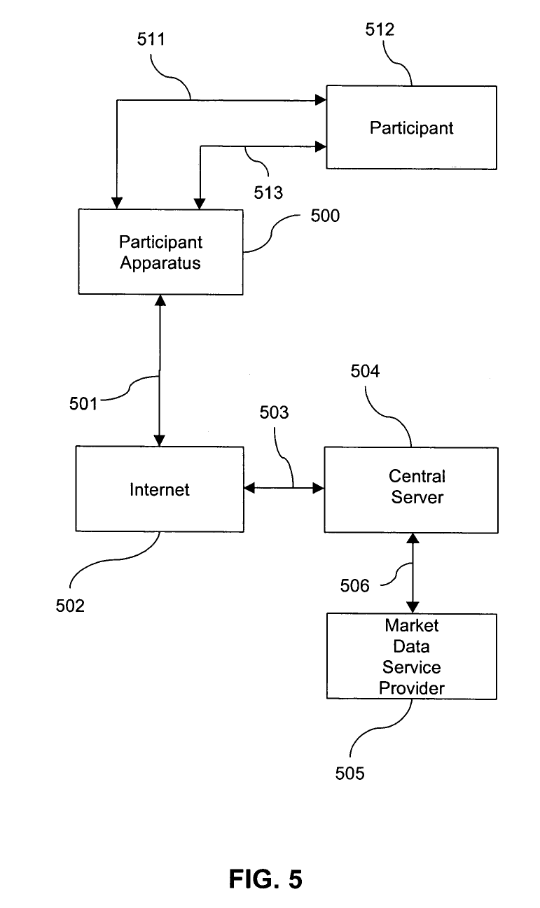

FIG. 5 is a diagram depicting a system consistent with the present invention. The system may be used to create and host a follow-on auction market. In the embodiment shown, a participant 512, who may be a buyer or seller, creates and/or modifies orders via an interactive computer application(s) hosted on a central server 504. A participant 512 communicates with the central server 504 via a participant apparatus 500. The participant apparatus 500 provides an interface whereby participants may create new orders and send them to the central server, cancel or change previously submitted orders that remain unmatched, receive notification from the central server when a trade occurs for an asset, receive notification regarding the timing and price of a follow-on call auction for an asset, and receive notification from the central server regarding the result of a completed follow-on auction, among other things. The participant apparatus 500 may be any number of commercially available hardware and software workstation products. The particular workstation hardware and software employed is not critical to the invention.

Participant 512 or other users of participant apparatus 500 may be natural persons acting for their own account or acting as agents for other legal entities. Further, it is well within the state of the art to assemble apparatus and software that could emulate the behavior of a natural person on the participant apparatus 500.

The participant apparatus 500 connects to the central server 504 via a conventional data communications network, such as the Internet 502. As shown, the participant apparatus 500 connects to the Internet 502 via an internet access service 501. An internet access service 501 is typically provided by an Internet Service Provider (not shown). The data communication network connecting the participant apparatus 500 to the server 504 can be any of a number of commercially available networks. The particular data communication network employed is not critical to the invention.

Participant 512 may interact with the participant apparatus 500 remotely via a wireless connection 513, such as a cell phone, using a local connection 511, such as keyboard and mouse, or by some other means known in the art. Central server 504 and participant apparatus 500 host software applications that support interactions initiated by the participant 512.

In one embodiment consistent with the invention, the central server computer 504 is configured with a software application(s) that performs, among other things, the tasks associated with implementing the order book, accepting orders from participants, comparing new orders to existing orders, matching orders, executing a trade for orders that match, detecting triggering events, such as continuous auction trades, scheduling and holding follow-on auctions, and notifying participants about trades, auction times, auction prices, and auction results. The central server system is comprised of conventional hardware and system software components familiar to one of ordinary skill in the art, along with specialized functions that may be routinely developed using tools and techniques well known in the art of computer programming. Conventional continuous auction systems are well known, and one of ordinary skill could modify such a system to implement functions and operations consistent with the invention. The particular system and software by which the invention is implemented are not critical to the invention.

In the embodiment shown, the central server 504 also hosts application software that obtains information from other markets. For example, under software control, the central server 504 may communicate 506 to a market data service provider 505 by making inquiries to obtain information regarding price quotations and trades of assets in other markets such as the New York Stock Exchange (NYSE). In one embodiment, a trade on another market, such as an NYSE trade, may trigger a follow-on auction for the same fungible asset, based on the NYSE trade price. The procedure for making electronic inquiries to a particular market data service provider are typically unique for each market data service provider. The market data service provider 505 is an entity that provides information concerning trades in public markets. Reuters is one example of a well-known provider of these services. Beyond the need to provide accurate trade price information, the selection of a particular market data service provider is not critical to the invention.

One of ordinary skill will realize that the components depicted in FIG. 5 can be easily added to, deleted, modified, or combined without departing from the principles of the present invention. For example, multiple instances of market data service providers 505, and participant apparatuses 500 could be employed, or the entire system shown in FIG. 5 could be duplicated in its entirety to either interact with similar systems or form separate discrete markets. As another example, service provider 505 could be eliminated.

One of ordinary skill will recognize that a prudently designed system will ensure that the applications, their data structures, the server system, and the networking technology are sufficiently secure so that information, for example about participant orders, cannot be surreptitiously obtained by others.

One of ordinary skill will also recognize that the invention may be implemented in purely software systems, in both hardware and software, or in purely hardware systems, as a routine design choice for the ordinary mechanic.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for trading fungible assets comprising:
obtaining a price for an asset from a continuous auction trade;
accepting a plurality of follow-on auction orders for the asset;
conducting a follow-on auction for the asset at a price determined as a function of the price obtained for the asset from the continuous auction trade, wherein the plurality of follow-on auction orders are matched; and
executing the matched follow-on auction orders.

2. The method of claim 1, further comprising:
conducting the continuous auction for the asset.

3. The method of claim 2, further comprising:
suspending the continuous auction for the asset while conducting the follow-on auction for the asset.

4. The method of claim 1, wherein conducting a follow-on auction for the asset at a price determined as a function of the price obtained for the asset from the continuous auction trade comprises:
conducting a follow-on auction for the asset at the exact price obtained for the asset in the continuous auction trade.

5. The method of claim 1, wherein the follow-on auction is limited to the asset traded in the continuous auction.

6. A system for trading fungible assets comprising:
means for obtaining a price for an asset from a continuous auction trade;
means for accepting a plurality of follow-on auction orders for the asset;
means for conducting a follow-on auction for the asset at a price determined as a function of the price obtained for the asset from the continuous auction trade, wherein the plurality of follow-on auction orders are matched; and
means for executing the matched follow-on auction orders.

7. The system of claim 6, further comprising:
means for conducting the continuous auction for the asset.

8. The system of claim 7, further comprising:
means for suspending the continuous auction for the asset while conducting the follow-on auction for the asset.

9. The system of claim 6, wherein the means for conducting a follow-on auction for the asset at a price determined as a function of the price obtained for the asset from the continuous auction trade comprises:
means for conducting a follow-on auction for the asset at the exact price obtained for the asset in the continuous auction trade.

10. The system of claim 6, wherein the follow-on auction is limited to the asset traded in the continuous auction.

11. A computer program product for trading fungible assets for causing a processor to perform operations comprising:
obtaining a price for an asset from a continuous auction trade;
accepting a plurality of follow-on auction orders for the asset;
conducting a follow-on auction for the asset at a price determined as a function of the price obtained for the asset from the continuous auction trade, wherein the plurality of follow-on auction orders are matched; and
executing the matched follow-on auction orders.

12. The computer program product of claim 11, further comprising:
conducting the continuous auction for the asset.

13. The computer program product of claim 12, further comprising:
suspending the continuous auction for the asset while conducting the follow-on auction for the asset.

14. The computer program product of claim 11, wherein conducting a follow-on auction for the asset at a price determined as a function of the price obtained for the asset from the continuous auction trade comprises: conducting a follow-on auction for the asset at the exact price obtained for the asset in the continuous auction trade.

15. The computer program product of claim 11, wherein the follow-on auction is limited to the asset traded in the continuous auction.

16. A method for trading fungible assets comprising:
(a) obtaining a price for an asset from a continuous auction trade;
(b) accepting a plurality of follow-on auction orders for the asset;
(c) conducting, after a delay period, a follow-on auction for the asset based on the price obtained for the asset from the continuous auction trade, during which the plurality of follow-on auction orders are processed for matches, if any; and
(d) facilitating execution of any matched orders.

17. A method of claim 16, further comprising:
conducting the continuous auction for the asset.

18. The method of claim 17, further comprising:
suspending the continuous auction for the asset while conducting the follow-on auction for the asset.

19. The method of claim 16 further comprising:
notifying a participant regarding the follow-on auction before the delay period ends.

20. The method of claim 19, wherein the participant is any participant in the continuous auction and the follow-on auction.

21. The method of claim 19, wherein the participant has an open order for the asset.

22. The method of claim 16, further comprising repeating (b) and (c) if a new continuous auction trade occurs before the delay period ends.

23. The method of claim 22, wherein the price obtained for the asset from the continuous auction trade is based on a price from the new continuous auction trade.

24. The method of claim 23, wherein the price obtained for the asset from the continuous auction trade is the price from the new continuous auction trade.

25. The method of claim 16, wherein conducting, after the end of the delay period, a follow-on auction for the asset based on the price obtained for the asset from the continuous auction trade comprises:
conducting, after the end of the delay period, a follow-on auction for the asset at the price obtained for the asset from the continuous auction trade.

26. A system for trading fungible assets comprising:
(a) means for obtaining a price for an asset from a continuous auction trade;
(b) means for accepting a plurality of follow-on auction orders for the asset;
(c) means for conducting, after a delay period, a follow-on auction for the asset based on the price obtained for the asset from the continuous auction trade, during which the plurality of follow-on auction orders are processed for matches, if any; and
(d) means for facilitating execution of any matched orders.

27. The system of claim 26, further comprising:
means for conducting the continuous auction for the asset.

28. The system of claim 27, further comprising:
means for suspending the continuous auction for the asset while conducting the follow-on auction for the asset.

29. The system of claim 26 further comprising:
notifying a participant regarding the follow-on auction before the delay period ends.

30. The system of claim 29, wherein the participant is any participant in the continuous auction and the follow-on auction.

31. The system of claim 29, wherein the participant has an open order for the asset.

32. The system of claim 26, further comprising
means for detecting whether a new continuous auction trade occurs before the delay period ends.

33. The system of claim 32, wherein the price obtained for the asset from the continuous auction trade is based on a price from the new continuous auction trade.

34. The system of claim 33, wherein the price obtained for the asset from the continuous auction trade is the price from the new continuous auction trade.

35. The system of claim 26, wherein the means for conducting, after a delay period, a follow-on auction for the asset based on the price obtained for the asset from the continuous auction trade comprises:
means for conducting, after a delay period, a follow-on auction for the asset at the price obtained for the asset from the continuous auction trade.

36. A computer program product for trading fungible assets for causing a processor to perform operations comprising:
(a) obtaining a price for an asset from a continuous auction trade;
(b) accepting a plurality of follow-on auction orders for the asset;
(c) conducting, after a delay period, a follow-on auction for the asset based on the price obtained for the asset from the continuous auction trade, during which the plurality of follow-on auction orders are processed for matches, if any; and
(d) facilitating execution of any matched orders.

37. The computer program product of claim 36, further comprising:
conducting the continuous auction for the asset.

38. The computer program product of claim 37, further comprising:
suspending the continuous auction for the asset while conducting the follow-on auction for the asset.

39. The computer program product of claim 36 further comprising:
notifying a participant regarding the follow-on auction before the delay period ends.

40. The computer program product of claim 39, wherein the participant is any participant in the continuous auction and the follow-on auction.

41. The computer program product of claim 39, wherein the participant has an open order for the asset.

42. The computer program product of claim 36, further comprising repeating (b) and (c) if a new continuous auction trade occurs before the delay period ends.

43. The computer program product of claim 42, wherein the price obtained for the asset from the continuous auction trade is based on a price from the new continuous auction trade.

44. The computer program product of claim 43, wherein the price obtained for the asset from the continuous auction trade is the price from the new continuous auction trade.

50. The computer program product of claim 36, wherein conducting, after the end of the delay period, a follow-on auction for the asset based on the price obtained for the asset from the continuous auction trade comprises:
conducting, after the end of the delay period, a follow-on auction for the asset at the price obtained for the asset from the continuous auction trade

51. A fungible asset market order comprising:
an order type from a group comprising: bid and offer;
an order price; and
an auction eligibility marker from a group comprising: continuous auction, follow-on auction, and both continuous and follow-on auction.

52. A method for trading fungible assets comprising:
obtaining a parameter regarding a continuous auction trade;
determining whether the parameter meets a threshold; and
conducting a follow-on auction for the asset, at a price established by the continuous auction trade, if the parameter meets the threshold.

53. The method of claim 54, wherein the threshold is a minimum trade quantity.

54. A system for trading fungible assets comprising:
means for obtaining a parameter regarding a continuous auction trade;
means for determining whether the parameter meets a threshold; and
means for conducting a follow-on auction for the asset, at a price established by the continuous auction trade, if the parameter meets the threshold.

55. The system of claim 54, wherein the threshold is a minimum trade quantity.
